(19) United States
(12) Patent Application Publication
(10) Pub. No.: US 2025/0154624 A1
(43) Pub. Date: May 15, 2025

(54) APPARATUS AND METHODS FOR LITHIUM, CALCIUM, AND MAGNESIUM EXTRACTION

(71) Applicants: The Regents of the University of California, Oakland, CA (US); UT-BATTELLE, LLC, Oak Ridge, TN (US)

(72) Inventors: Gaurav Sant, Los Angeles, CA (US); Ross Arnold, Los Angeles, CA (US); Mathieu Bauchy, Los Angeles, CA (US); Dante Simonetti, Los Angeles, CA (US); Xin Chen, Los Angeles, CA (US); David Jassby, Los Angeles, CA (US); Lawrence Anovitz, Oak Ridge, TN (US); Elena Tajuelo Rodriguez, Oak Ridge, TN (US)

(21) Appl. No.: 18/838,902

(22) PCT Filed: Feb. 15, 2023
(86) PCT No.: PCT/US2023/062624

§ 371 Date: Aug. 15, 2024

Related U.S. Application Data
(60) Provisional application No. 63/310,833, filed on Feb. 16, 2022.

(51) Int. Cl. C22B 3/22; C22B 3/02; C22B 26/12; C22B 26/22

(52) U.S. Cl. CPC C22B 3/22; C22B 3/02; C22B 26/12; C22B 26/22

(57) ABSTRACT

Provided herein are assemblies and methods for lithium, magnesium, and/or calcium extraction. In various embodiments, an assembly includes a leaching tank defining an interior chamber having one or more inlets and one or more outlets. The leaching tank is configured to receive through the one or more inlets a mixture comprising a substrate having one or more target metals and a solvent. The assembly further includes a sonic probe positioned within the interior chamber, suspended in the solution, and/or a sonic plate configured to provide sonic energy to the mixture.

### RELATED APPLICATIONS

This application claims the benefit of priority to U.S. Provisional Patent Application No. 63/310,833, filed Feb. 16, 2022; the contents of which are hereby incorporated by reference in their entirety.

### STATEMENT OF GOVERNMENT SUPPORT

This invention was made with government support under DE-AC05-00OR22725, and DE-AR0001147 awarded by the U.S. Department of Energy. The government has certain rights in the invention.

### FIELD OF THE INVENTION

Embodiments of the present disclosure generally relate to apparatuses and processes for the selective extraction of lithium, calcium, and magnesium. More specifically, the present disclosure relates to ultrasonic apparatuses and processes for the selective extraction of lithium and magnesium from suitable geological precursors and alkaline industrial waste materials.

### BACKGROUND

Lithium, magnesium, and calcium are key raw elements for applications such as lithium-ion batteries, magnesium-aluminum alloys, and calcium compounds, respectively. Moreover, lithium compounds are used in many commercial applications including batteries, glass, ceramics, lubricating greases, and other industrial products. Global lithium consumption has significantly increased in the recent decades and is projected to reach 0.2 million tons by 2030. These elements may be extracted from natural precursors and alkaline industrial wastes by first grinding the solid sources to particles to a median size as low as 5 μm followed by acid-leaching. However, these techniques are energy intensive and can be harmful to the environment.

### SUMMARY OF THE INVENTION

The present disclosure provides in some embodiments a method of selectively extracting one or more target metals from a mixture where a solid substrate comprising the one or more target metals is combined with a solvent in a leaching tank to thereby form the mixture. Acoustic energy is applied to the mixture to thereby separate the one or more target metals from non-target materials. The one or more target metals are output in a target metal-rich stream.

In various embodiments, an assembly is provided including a leaching tank defining an interior chamber having one or more inlets and one or more outlets. The leaching tank is configured to receive through the one or more inlets a mixture comprising a substrate having one or more target metals, semi-metals, etc. and a solvent. The assembly includes an acoustic probe disposed within the interior chamber and configured to provide sonic energy to the mixture, a sonic plate in contact with the leaching tank and configured to provide sonic energy to the mixture, or both the sonic probe and the sonic plate.

### BRIEF DESCRIPTION OF THE SEVERAL VIEWS OF THE DRAWINGS

FIG. 1A illustrates a continuous stirred tank reactor for ultrasonic Li, Mg, and/or Ca extraction in accordance with an embodiment of the present disclosure.

FIG. 1B illustrates a process flow diagram for ultrasonic Li, Mg and/or Ca extraction in accordance with an embodiment of the present disclosure.

FIG. 2 illustrates a graph of energy savings of ultrasonically stimulated lizardite dissolution at megasonic (1 MHz) and ultrasonic (20 kHz) frequencies as compared to stirred, heated dissolution in accordance with an embodiment of the present disclosure.

FIG. 3A illustrates a graph of relative dissolution rate increase induced by ultrasonic dissolution as a function of substrate surface energy in accordance with an embodiment of the present disclosure.

FIG. 3B illustrates a graph of relative dissolution rate increase induced by ultrasonic dissolution as a function of substrate stacking fault energy in accordance with an embodiment of the present disclosure.

### DETAILED DESCRIPTION

Certain target metals, such as alkaline earth metals, may be extracted from natural precursors (e.g., minerals, ores, etc.) and/or recycled from industrial wastes (e.g., alkaline industrial waste), lithium-ion batteries, etc. When processing solid materials containing these target metals, the solid materials are generally ground into fine powders (with particle sizes having a median size as small as 5 μm), and the powder is mixed in an acidic bath with a solvent that allows the target metal(s) to dissolve into solution. However, these processes are energy intensive and harmful to the environment.

The present invention advantageously uses acoustic (e.g., ultrasonic) stimulation of a mixture having a substrate and a solvent, which can be used to selectively extract the target metal(s) (e.g., Li and/or Mg) from the substrate. The substrate may be a solid substrate, such as a particulate substrate. Sonic stimulation offers a rapid, low-energy, additive-free route compared to conventional grinding and leaching. Depending on the frequency, acoustic stimulation may also be referred to herein as ultrasonication, sonic or ultrasonic stimulation, or ultrasonic perturbation.

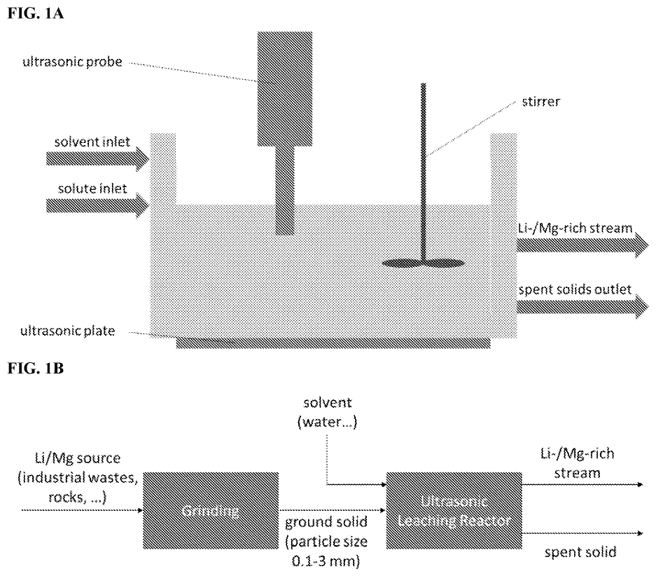

FIG. 1A illustrates an ultrasonic continuous-stirred tank reactor (CSTR) for lithium and/or magnesium extraction and FIG. 1B illustrates a process flow diagram for ultrasonic lithium and/or magnesium extraction. Ultrasonic stimulation allows for rapid dissolution of appropriate substrates without expensive energy-intensive additives, long soaking times, heating, and/or ultrafine grinding that may be required in processes known in the art.

In one aspect, the present disclosure provides a method of selectively extracting one or more target metals from a mixture, the method comprising:
combining, in a leaching tank, a solid substrate comprising the one or more target metals/elements and a solvent to thereby form the mixture;
applying sonic energy to the mixture to thereby separate the one or more target metals from non-target materials;
outputting the one or more target metals in a target metal-rich stream.

In certain embodiments, the method further comprises outputting the non-target materials.

In certain embodiments, the target metal-rich stream is output in a first outlet and the non-target materials are output in a second outlet.

In certain embodiments, the leaching tank further comprises a stirring device.

In certain embodiments, the leaching tank is configured to operate as a batch reactor.

In various embodiments, a solvent is provided into a reactor (e.g., a leaching tank). In various embodiments, the solvent includes at least one of: water, alcohols (e.g., methanol, ethanol, isopropanol, etc.), acetone, organic solvents (e.g., pentane, hexane, benzene, toluene, diethyl ether, tetrahydrofuran, chloroform, etc.), polyethylene glycol, hydrogen peroxide, and any combination thereof. In some embodiments, the solvent provided to the reactor has a pH ranging from about 5.5 to about 8.5, about 6 to about 8, or about 6.5 to about 7.5. In other embodiments, the solvent has a pH ranging from about 1 to about 6, about 1 to about 5, or about 1 to about 4. In other embodiments, the solvent has a pH ranging from about 1 to about 5. In various embodiments, a solid substrate having one or more target metals is provided to the reactor. In various embodiments, the solid substrate and solvent are provided to the reactor via the same inlet. In various embodiments, the solid substrate and solvent are provided to the reactor via separate inlets. In various embodiments, the solvent and solid substrate are provided to the reactor at the same flow rate (e.g., mass flow rate, volumetric flow rate). In various embodiments, the solvent and solid substrate are provided to the reactor at different flow rates (e.g., mass flow rate, volumetric flow rate).

In various embodiments, the solvent includes a mixture of a mineral acid and water. In various embodiments, the mineral acid is selected from but not restricted to: hydrofluoric acid, hydrochloric acid, hydrobromic acid, hydroiodic acid, boric acid, phosphoric acid, nitric acid, perchloric acid, and sulfuric acid. In various embodiments, the concentration of the mineral acid in the solvent and acid mixture is up to about 1 mol/L. In various embodiments, the pH of the mixture is about 0 to about 7, preferably about 0.5 to about 5.

In various embodiments, the solvent includes a mixture of an organic acid and water. In various embodiments, the organic acid is selected from but not restricted to: acetic acid, acetylsalicylic acid, carbonic acid, and citric acid. In various embodiments, the concentration of the organic acid in the solvent and acid mixture is up to about 1 mol/L. In various embodiments, the pH of the solvent and acid mixture is about 0 to about 7, preferably about 1 to about 5.

In various embodiments, the target metal is dissolved in the solvent in the reactor with ultrasonic stimulation at a frequency of about 18 kHz to about 2000 kHz. In various embodiments, the ultrasonic stimulation frequency is about 20 kHz to about 40 kHz. In various embodiments, the ultrasonic stimulation frequency is about 800 kHz to about 1200 kHz. In various embodiments, the ultrasonic stimulation frequency is greater than or equal to about 18 kHz. In various embodiments, the ultrasonic stimulation frequency is less than or equal to about 2000 kHz. In various embodiments, the ultrasonic stimulation frequency is about 20 kHz. In various embodiments, the ultrasonic stimulation frequency is about 30 kHz. In various embodiments, the ultrasonic stimulation frequency is about 40 kHz. In various embodiments, the ultrasonic stimulation frequency is about 50 kHz. In various embodiments, the ultrasonic stimulation frequency is about 60 kHz. In various embodiments, the ultrasonic stimulation frequency is about 70 kHz. In various embodiments, the ultrasonic stimulation frequency is about 80 kHz. In various embodiments, the ultrasonic stimulation frequency is about 90 kHz. In various embodiments, the ultrasonic stimulation frequency is about 100 kHz. In various embodiments, the ultrasonic stimulation frequency is about 200 kHz. In various embodiments, the ultrasonic stimulation frequency is about 300 kHz. In various embodiments, the ultrasonic stimulation frequency is about 400 kHz. In various embodiments, the ultrasonic stimulation frequency is about 500 kHz. In various embodiments, the ultrasonic stimulation frequency is about 600 kHz. In various embodiments, the ultrasonic stimulation frequency is about 700 kHz. In various embodiments, the ultrasonic stimulation frequency is about 800 kHz. In various embodiments, the ultrasonic stimulation frequency is about 900 kHz. In various embodiments, the ultrasonic stimulation frequency is about 1000 kHz (1 MHz). In various embodiments, the ultrasonic stimulation frequency is about 1100 kHz (1.1 MHZ). In various embodiments, the ultrasonic stimulation frequency is about 1200 kHz (1.2 MHz). In various embodiments, the ultrasonic stimulation frequency is about 1300 kHz (1.3 MHZ). In various embodiments, the ultrasonic stimulation frequency is about 1400 kHz (1.4 MHZ). In various embodiments, the ultrasonic stimulation frequency is about 1500 kHz (1.5 MHz). In various embodiments, the ultrasonic stimulation frequency is about 1600 kHz (1.6 MHz). In various embodiments, the ultrasonic stimulation frequency is about 1700 kHz (1.7 MHz). In various embodiments, the ultrasonic stimulation frequency is about 1800 kHz (1.8 MHZ). In various embodiments, the ultrasonic stimulation frequency is about 1900 kHz (1.9 MHZ). In various embodiments, the ultrasonic stimulation frequency is about 2000 kHz (2 MHZ). In various embodiments, the ultrasonic stimulation frequency is about 3000 kHz (3 MHz). In various embodiments, the ultrasonic stimulation frequency is about 4000 kHz (4 MHZ). In various embodiments, the ultrasonic stimulation frequency is about 5000 kHz (5 MHz). In various embodiments, the ultrasonic stimulation frequency is about 6000 kHz (6 MHz). In various embodiments, the ultrasonic stimulation frequency is about 7000 kHz (7 MHz). In various embodiments, the ultrasonic stimulation frequency is about 8000 kHz (8 MHz). In various embodiments, the ultrasonic stimulation frequency is about 9000 kHz (9 MHz). In various embodiments, the ultrasonic stimulation frequency is about 10,000 kHz (10 MHz). In various embodiments, the ultrasonic stimulation frequency is about 11,000 kHz (11 MHz). In various embodiments, the ultrasonic stimulation frequency is about 12,000 kHz (12 MHz). In various embodiments, the ultrasonic stimulation frequency is about 13,000 kHz (13 MHz). In various embodiments, the ultrasonic stimulation frequency is about 14,000 kHz (14 MHz). In various embodiments, the ultrasonic stimulation frequency is about 15,000 kHz (15 MHZ).

In various embodiments, the acoustic stimulation is provided by a acoustic probe that is at least partially submerged in the solvent-substrate mixture. In various embodiments, the sonic stimulation is provided by a sonic probe that is at least partially submerged in the solvent-substrate mixture. In various embodiments, the ultrasonic stimulation is provided by one or more ultrasonic plates in contact with the reactor. In still further embodiments, the ultrasonic stimulation is provided by both a sonic (e.g., ultrasonic) probe and a sonic (e.g., ultrasonic) plate. In various embodiments, the sonic probe causes agitation of the solvent due to the rapid motion of the probe. In various embodiments, particularly where the ultrasonic plate is used for sonic stimulation, a stirrer may be disposed within the reactor to ensure thorough mixing of the solvent. In various embodiments, an effluent liquid stream from the reactor is enriched in the target metal (e.g., Li, Mg, and/or Ca). In various embodiments, the as to-be-leached solid substrate contains other less-soluble elements, such as silicon (Si) and aluminum (Al), a portion of the solid substrate remains undissolved, and may be removed as spent solid. In various embodiments, the spent solid is passed through a spent solid outlet.

In various embodiments, ultrasonic stimulation of the solid particles within the substrate-solvent mixture allows for larger particle sizes to be effective for leaching compared to acid leaching, lowering any required grinding energy of the process. In various embodiments, the particles may be about 100 μm or greater. In various embodiments, the particles have an average diameter of about 500 nm to 5 mm, about 100 μm to about 5 mm, about 500 μm to about 5 mm, or about 500 μm to about 3 mm. In various embodiments, the leaching tank may be operated as a continuous flow reactor. In various embodiments, the leaching tank may be operated as a batch reactor. In various embodiments, the leaching tank may be operated as a plug flow reactor (PFR) mode. In various embodiments, the leaching tank may be operated as a fixed- or fluidized-bed reactor. In various embodiments, the particular choice of mode may depend on dissolution rate of the target metal, as well as the operational nature of the downstream application(s) for the lithium- and/or magnesium-rich stream. In various embodiments, the substrate includes but is not restricted to: lizardite, antigorite, basalt, spodumene, forsterite, enstatite, merwinite, petalite, lepidolite, eucryptite, and/or virgilite.

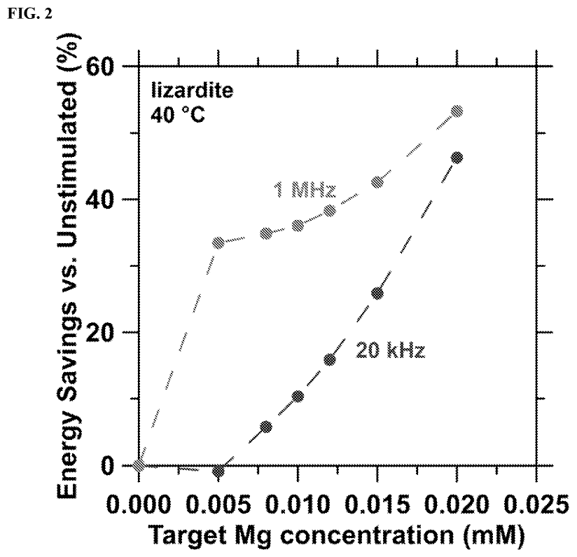

FIG. 2 illustrates a graph of energy savings of acoustically stimulated lizardite (Mg₃Si₂O₅(OH)₄) dissolution at megasonic (1 MHZ) and ultrasonic (20 kHz) frequencies as compared to stirred, heated dissolution. As shown in FIG. 2, 0.023 mM was the greatest obtainable Mg concentration without sonic stimulation. Sonic stimulation offers a lower-energy pathway compared to stirred, heated dissolution for alkaline industrial wastes. As shown in FIG. 2, a similar reduction in processing energy was observed for Mg extraction from lizardite, demonstrating that both ultrasonic (20 kHz) and megasonic (1 MHz) dissolution are less energetically-intensive than unstimulated dissolution. FIG. 2 shows that the energy consumption for ultrasonic extraction of Mg is about 0.33 kWh/t. Comparably, production of the stoichiometric amount of acid (in this case, HNO₃) required to extract Mg (i.e., 2 mol of HNO₃ per 1 mol of extracted Mg) requires 0.19 kWh/t and grinding particles from 3 mm to 5 μm requires 0.09 kWh/t. Unsonicated dissolution further consumes energy for agitation/heating (˜0.15-0.25 kWh/t), energy which is intrinsically supplied by ultrasonication. Acid manufacture, in contrast, requires caustic feedstocks (e.g., ammonia for HNO₃), and produces contaminants (e.g., NOx for HNO₃) as byproducts. Acidic dissolution produces an effluent stream that is rich in the anions from the feed acid (e.g., NO₃⁻ from HNO₃), which must further be extracted/separated by techniques such as liquid-liquid extraction or sorption. In various embodiments, ultrasonic extraction without chemical additives advantageously produces a relatively benign waste stream, containing only the non-Mg, non-Li components of the substrate. In various embodiments, an ultrasonic or megasonic stimulation pathway offers a low-energy, non-toxic option for the extraction of Mg and Li from geological precursors and alkaline industrial wastes when compared to unstimulated acidic leaching options. In various embodiments, extraction rates using ultrasonic stimulation have reached 10% of the rate of acidic leaching from prior methods described in literature, and process scaling and optimization may improve (i.e., reduce) this leaching rate. However, the increased energy efficiency and elimination of a toxic waste stream are benefits which may outweigh the reduced extraction rates.

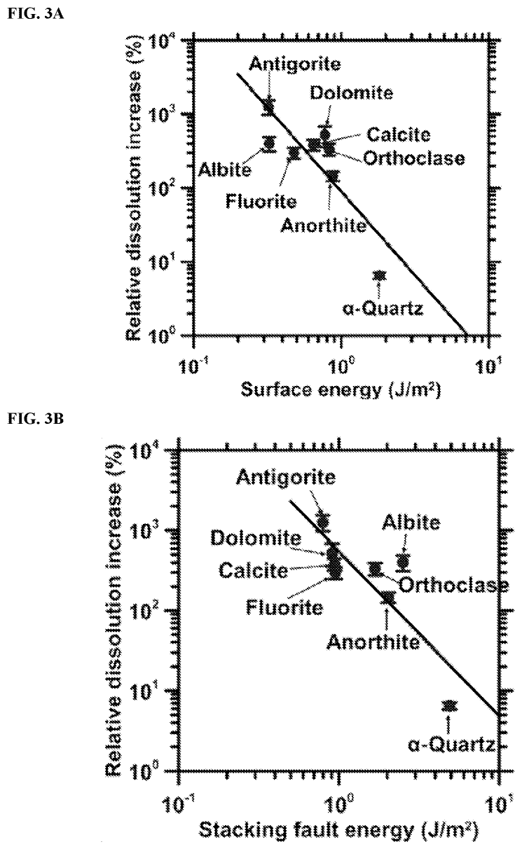

FIG. 3A illustrates a graph of relative dissolution rate increase induced by ultrasonic dissolution as a function of substrate surface energy and FIG. 3B illustrates a graph of relative dissolution rate increase induced by ultrasonic dissolution as a function of substrate stacking fault energy. In various embodiments, the effectiveness of ultrasonication for stimulating dissolution has been shown to inversely correlate (e.g., negatively correlate on a log-log scale) with two fundamental material properties. As shown in FIGS. 3A-3B, the surface energy (i.e., resistance of particles to fracture) and the stacking fault energy (i.e., resistance of particle to formation of faults such as defects and plastic deformations) are each inversely correlated to the relative dissolution rate increase. In this way, ultrasonication can be used to accelerate the innate dissolution rate by a factor of tenfold or greater for materials with low surface and stacking fault energies, such as Mg antigorite (Mg₃Si₂O₅(OH)₄) and dolomite (CaMg(CO₃)₂). In various embodiments, the effectiveness of ultrasonic dissolution increases with decreasing bond energy of the target element(s), with Mg—O (394 KJ/mol)<Ca-O (464 KJ/mol)<Al-O (512 kJ/mol)<Si—O (798 KJ/mol). In various embodiments, ultrasonication represents a pathway that may be applied to general Mg extraction from other minerals such as talc (Mg₃Si₄O₁₀(OH)₂) and Mg-olivine (Mg₂SiO₄), as well as Mg-containing waste materials such as magnesium slag, due to the low Mg—O bond energy, and hypothesized corresponding low surface and stacking fault energies, in these substrates.

For lithium extraction, the bond energy of Li—O is 341 KJ/mol, slightly lower than that of Mg—O. In various embodiments, cavitation energy provided by ultrasonication is energetically suitable for rapid lithium extraction from Li-containing minerals such as spodumene (LiAl(SiO₃)₂) and petalite (LiAl(Si₂O₅)₂), and Li-containing waste materials, including spent Li batteries. In various embodiments, the low bond energies of Li and Mg specifically, when compared to other elements (e.g., Ca, Al, Si) show that targeted sonic stimulation energies can selectively and preferentially liberate Li and Mg into solution, allowing for formation of target Mg and Li phases with little or no contamination with other elemental species. In various embodiments, ultrasonic stimulation allows for selective, targeted extraction of Li and/or Mg from mineral phases, after which extraction of other desirable phases may take place. In various embodiments, a sequential sonic treatment reduces or removes the need for downstream separation of solids by tuning the extraction processes to the desired elements (e.g., two or more leaching tanks connected in series, with the downstream leaching tanks receiving the previous tank's target metal-rich stream).

In various embodiments, the extraction of lithium and/or magnesium is accelerated by sonic stimulation at the resonance frequency of the particle. In various embodiments, molecular dynamics simulations are used to determine the resonance frequency. In various embodiments, the sonic stimulation is at an ultrasonic frequency (e.g., about 18 kHz or about 18 kHz to less than 1 MHz). In various embodiments, the sonic stimulation is at the megasonic frequency of about 1 MHz or above 1 MHz. In various embodiments, about 1 MHz corresponds to the resonance frequency for Mg-antigorite with a particle size of 3.509 mm and for dolomite with a particle size of 3.382 mm. In various embodiments, the resonance frequency increases linearly as a function of sound velocity through the particles, which is a function of solely particle composition and structure. In various embodiments, the resonance frequency increases linearly as a function of bulk modulus, which is a function of particle composition, structure and/or size. In various embodiments, the resonance frequency occurs in different nodes in either a spheroidal or torsional oscillation mode. In various embodiments, the resonant frequencies described herein correspond to torsional oscillation in the first node, as this corresponds to the lowest particle size which displays the target resonance frequency. In various embodiments, resonance stimulation leads to rapid vibrations of the particles, rapidly liberating desired element(s) into solution. In various embodiments, targeting particles with a diameter greater than 3 mm reduces or eliminates the need for extensive grinding. In various embodiments, due to the similar compositions and average bond energies of Mg- and Li-containing minerals and waste materials, the particle sizes (e.g., median sizes) that correspond to a resonance frequency of 1 MHz are in the range of particle size viability for an aqueous liberation pathway (estimated as approximately 0.5 nm to 5 mm).

In another aspect, the present disclosure provides an assembly comprising:
a leaching tank defining an interior chamber having one or more inlets and one or more outlets, wherein the leaching tank is configured to receive through the one or more inlets a mixture comprising a substrate having one or more target metals and a solvent; and
a sonic probe positioned within the interior chamber and configured to provide sonic energy to the mixture, a sonic plate in contact with the leaching tank and configured to provide sonic energy to the mixture, or both the sonic probe and the sonic plate.

In certain embodiments, the one or more inlets comprise a solvent inlet. In certain embodiments, the one or more inlets comprise a substrate inlet. In certain embodiments, the one or more outlets comprise a target metal-rich stream. In certain embodiments, the one or more outlets comprise a spent solids outlet.

In certain embodiments, the leaching tank further comprises a stirring device.

In certain embodiments, the assembly comprises the sonic probe. In certain embodiments, the assembly comprises the sonic plate.

In certain embodiments, the leaching tank is configured to operate as a batch reactor. In certain embodiments, the leaching tank is configured to operate as a plug-flow reactor. In certain embodiments, the leaching tank is configured to operate as a continuous flow reactor. In certain embodiments, the leaching tank is configured to operate as a fixed-bed reactor. In certain embodiments, the leaching tank is configured to operate as a fluidized-bed reactor.

In certain embodiments, the one or more target metals comprise one or more alkali metals or one or more alkaline earth metals. In certain embodiments, one or more alkali metals comprise lithium. In certain embodiments, the one or more alkaline earth metals comprise magnesium. In certain embodiments, the one or more alkaline earth metals comprise magnesium.

In certain embodiments, the sonic probe is configured to provide sonic energy at a frequency of about 18 kHz to about 2 MHz.

In certain embodiments, the sonic probe is configured to provide sonic energy at one or more resonant frequencies of the substrate.

What is claimed is:

1. A method of selectively extracting one or more target elements from a mixture, the method comprising:
combining, in a leaching tank, a solid substrate comprising the one or more target elements and a solvent to thereby form the mixture;
applying acoustic energy to the mixture to thereby separate the one or more target species from non-target materials;
outputting the one or more target metals in a target species-rich stream.

2. A method of selectively extracting one or more target metals from a mixture, the method comprising:
combining, in a leaching tank, a solid substrate comprising the one or more target metals a solvent and to thereby form the mixture;
applying sonic energy to the mixture to thereby separate the one or more target metals from non-target materials;
outputting the one or more target metals in a target metal-rich stream.

3. The method of claim 1 or 2, further comprising outputting the non-target materials.

4. The method of claim 3, wherein the target metal-rich stream is output in a first outlet and the non-target materials are output in a second outlet.

5. The method of any one of claims 1 to 4, wherein leaching tank further comprises a stirring device.

6. The method of any one of claims 1 to 5, wherein the leaching tank is configured to operate as a batch reactor.

7. The method of any one of claims 1 to 5, wherein the leaching tank is configured to operate as continuous stirred tank reactor.

8. The method of any one of claims 1 to 5, wherein the leaching tank is configured to operate as a plug-flow reactor.

9. The method of any one of claims 1 to 5, wherein the leaching tank is configured to operate as a continuous flow reactor.

10. The method of any one of claims 1 to 5, wherein the leaching tank is configured to operate as a fixed-bed reactor.

11. The method of any one of claims 1 to 5, wherein the leaching tank is configured to operate as a fluidized-bed reactor.

12. The method of any one of claims 1 to 11, wherein the leaching tank is configured to operate in series (e.g., with one or more other leaching reactors).

13. The method of any one of claims 1 to 11, wherein the leaching tank is configured to operate in parallel (e.g., with one or more other leaching reactors).

14. The method of any one of claims 1 to 13, wherein the one or more target metals comprise one or more alkali metals or one or more alkaline earth metals.

15. The method of claim 14, wherein the one or more alkali metals comprise lithium.

16. The method of claim 14 or claim 15, wherein the one or more alkaline earth metals comprise magnesium.

17. The method of any one of claims 14 to 16, wherein the one or more alkaline earth metals comprise calcium.

18. The method of any one of claims 1 to 17, wherein the acoustic energy is applied via a sonic probe extending into the mixture.

19. The method of any one of claims 1 to 17, wherein the sonic energy is applied via a sonic probe extending into the mixture.

20. The method of claim 18 or 19, wherein the mixture is flowing.

21. The method of any one of claims 1 to 20, wherein the acoustic energy is applied via a sonic plate in contact with the leaching tank.

22. The method of any one of claims 1 to 20, wherein the sonic energy is applied via a sonic plate in contact with the leaching tank.

23. The method of any one of claims 1 to 22, wherein the acoustic probe is configured to provide acoustic energy at different frequencies (and amplitudes) that may represent one or more resonant frequencies of the solid substrate comprising the target metal.

24. The method of any one of claims 1 to 22, wherein the sonic probe is configured to provide sonic energy at one or more resonant frequencies of the solid substrate comprising the target metal.

25. The method of any one of claims 1 to 24, wherein the sonic energy has a frequency of about 18 kHz to about 2 MHz.

26. The method of any one of claims 1 to 24, wherein the acoustic energy has a frequency of about 2 Hz to about 200 MHz.

27. The method of any one of claims 1 to 24, wherein the acoustic energy has a frequency of about 1 Mhz.

28. The method of any one of claims 1 to 24, wherein the acoustic energy has a frequency of about 1.1 Mhz.

29. The method of any one of claims 1 to 24, wherein the acoustic energy has a frequency of about 1.2 Mhz.

30. The method of any one of claims 1 to 24, wherein the acoustic energy has a frequency of about 1.3 Mhz.

31. The method of any one of claims 1 to 24, wherein the acoustic energy has a frequency of about 1.4 Mhz.

32. The method of any one of claims 1 to 24, wherein the acoustic energy has a frequency of about 1.5 Mhz.

33. The method of any one of claims 1 to 24, wherein the acoustic energy has a frequency of about 1.6 Mhz.

34. The method of any one of claims 1 to 24, wherein the acoustic energy has a frequency of about 1.7 Mhz.

35. The method of any one of claims 1 to 24, wherein the acoustic energy has a frequency of about 1.8 Mhz.

36. The method of any one of claims 1 to 24, wherein the acoustic energy has a frequency of about 1.9 Mhz.

37. The method of any one of claims 1 to 24, wherein the acoustic energy has a frequency of about 2 Mhz.

38. The method of any one of claims 1 to 24, wherein the acoustic energy has a frequency of about 3 Mhz.

39. The method of any one of claims 1 to 24, wherein the acoustic energy has a frequency of about 4 Mhz.

40. The method of any one of claims 1 to 24, wherein the acoustic energy has a frequency of about 5 Mhz.

41. The method of any one of claims 1 to 24, wherein the acoustic energy has a frequency of about 6 Mhz.

42. The method of any one of claims 1 to 24, wherein the acoustic energy has a frequency of about 7 Mhz.

43. The method of any one of claims 1 to 24, wherein the acoustic energy has a frequency of about 8 Mhz.

44. The method of any one of claims 1 to 24, wherein the acoustic energy has a frequency of about 9 Mhz.

45. The method of any one of claims 1 to 24, wherein the acoustic energy has a frequency of about 10 Mhz.

46. The method of any one of claims 1 to 24, wherein the acoustic energy has a frequency of about 11 Mhz.

47. The method of any one of claims 1 to 24, wherein the acoustic energy has a frequency of about 12 Mhz.

48. The method of any one of claims 1 to 24, wherein the acoustic energy has a frequency of about 13 Mhz.

49. The method of any one of claims 1 to 24, wherein the acoustic energy has a frequency of about 14 Mhz.

50. The method of any one of claims 1 to 24, wherein the acoustic energy has a frequency of about 15 Mhz.

51. The method of any one of claims 1 to 50, wherein the substrate comprises particles having a median diameter of 5 micrometers to about 50 mm.

52. The method of any one of claims 1 to 51, wherein the substrate comprises particles having a median diameter of 0.5 nm to about 5 mm.

53. The method of any one of claims 1 to 51, wherein the substrate comprises particles having a median diameter of 0.5 mm to about 5 mm.

54. The method of any one of claims 1 to 53, wherein the solvent is an aqueous solvent.

55. The method of claim 54, wherein the solvent is water.

56. The method of any one of claims 1 to 53, wherein the solvent comprises at least one of: methanol, ethanol, isopropanol, acetone, pentane, hexane, benzene, toluene, diethyl ether, tetrahydrofuran, chloroform, polyethylene glycol, hydrogen peroxide, and any combination thereof.

57. The method of any one of claims 1 to 53, wherein the solvent comprises a mixture of a base and water.

58. The method of claim 57, wherein the base is a hydroxide.

59. The method of any one of claims 1 to 53, wherein the solvent comprises a mixture of a mineral acid and water.

60. The method of claim 59, wherein the mineral acid is selected from: hydrofluoric acid, hydrochloric acid, hydrobromic acid, hydroiodic acid, boric acid, phosphoric acid, nitric acid, perchloric acid, and sulfuric acid.

61. The method of claim 59 or claim 60, wherein a concentration of the mineral acid in the mixture is up to about 1 mol/L.

62. The method of any one of claims 1 to 53, wherein the solvent comprises a mixture of an organic acid and water.

63. The method of claim 62, wherein the organic acid is selected from: acetic acid, acetylsalicylic acid, carbonic acid, and citric acid.

64. The method of claim 62 or claim 63, wherein a concentration of the organic acid in the mixture is up to about 20 mol/L.

65. The method of claim 62 or claim 63, wherein a concentration of the organic acid in the mixture is up to about 1 mol/L.

66. The method of any one of claims 54 to 65, wherein the pH of the mixture is about 0 to about 14.

67. The method of any one of claims 59 to 66, wherein the pH of the mixture is about 0 to about 7.

68. The method of any one of claims 54 to 58, wherein the pH of the mixture is about 7 to about 14.

69. The method of any one of claims 59 to 66, wherein the solvent has a pH of about 0.5 to about 13.5.

70. The method of any one of claims 59 to 66, wherein the solvent has a pH of about 5.5 to about 8.5.

71. An assembly comprising:
a leaching tank defining an interior chamber having one or more inlets and one or more outlets, wherein the leaching tank is configured to receive through the one or more inlets a mixture comprising a substrate having one or more target metals and a solvent; and
an acoustic probe positioned within the interior chamber and configured to provide acoustic energy to the mixture, an acoustic plate in contact with the leaching tank and configured to provide acoustic energy to the mixture, or both the sonic probe and the sonic plate, and including flowing/suspended acoustic probes.

72. An assembly comprising:
a leaching tank defining an interior chamber having one or more inlets and one or more outlets, wherein the leaching tank is configured to receive through the one or more inlets a mixture comprising a substrate having one or more target metals and a solvent; and
a sonic probe positioned within the interior chamber and configured to provide sonic energy to the mixture, a sonic plate in contact with the leaching tank and configured to provide sonic energy to the mixture, or both the sonic probe and the sonic plate.

73. The assembly of claim 71 or 71, wherein the one or more inlets comprise a solvent inlet.

74. The assembly of any one of claims 71 to 73, wherein the one or more inlets comprise a substrate inlet.

75. The assembly of any one of claims 71 to 74, wherein the one or more outlets comprise a target metal-rich stream.

76. The assembly of any one of claims 71 to 75, wherein the one or more outlets comprise a spent solids outlet.

77. The assembly of any one of claims 71 to 76, wherein the leaching tank further comprises a stirring device.

78. The assembly of any one of claims 71 to 77, wherein the assembly comprises the sonic probe.

79. The assembly of any one of claims 71 to 78, wherein the assembly comprises the sonic plate.

80. The assembly of any one of claims 71 to 79, wherein the leaching tank is configured to operate as a batch reactor.

81. The assembly of any one of claims 71 to 79, wherein the leaching tank is configured to operate as a plug-flow reactor.

82. The assembly of any one of claims 71 to 79, wherein the leaching tank is configured to operate as a continuous flow reactor.

83. The assembly of any one of claims 71 to 79, wherein the leaching tank is configured to operate as a fixed-bed reactor.

84. The assembly of any one of claims 71 to 79, wherein the leaching tank is configured to operate as a fluidized-bed reactor.

85. The assembly of any one of claims 71 to 79, wherein the leaching tank is configured to operate as continuous stirred tank reactor.

86. The assembly of any one of claims 71 to 85, wherein the leaching tank is configured to operate in series (e.g., with one or more other leaching reactors).

87. The assembly of any one of claims 71 to 85, wherein the leaching tank is configured to operate in parallel (e.g., with one or more other leaching reactors).

88. The assembly of any one of claims 71 to 87, wherein the one or more target metals comprise one or more alkali metals or one or more alkaline earth metals.

89. The assembly of claim 88, wherein the one or more alkali metals comprise lithium.

90. The assembly of claim 88 or claim 89, wherein the one or more alkaline earth metals comprise magnesium.

91. The assembly of any one of claims 88 to 90, wherein the one or more alkaline earth metals comprise magnesium.

92. The assembly of any one of claims 71 to 91, wherein the sonic probe is configured to provide sonic energy at a frequency of about 2 Hz to about 200 MHz.

93. The assembly of any one of claims 71 to 92, wherein the sonic probe is configured to provide sonic energy at a frequency of about 18 kHz to about 2 MHz.

94. The assembly of any one of claims 71 to 93, wherein the sonic probe is configured to provide sonic energy at one or more resonant frequencies of the substrate.

95. The method of any one of claims 71 to 94, wherein the acoustic energy has a frequency of about 2 Hz to about 200 MHz.

96. The assembly of any one of claims 71 to 94, wherein the acoustic energy has a frequency of about 1 Mhz.

97. The assembly of any one of claims 71 to 94, wherein the acoustic energy has a frequency of about 1.1 Mhz.

98. The assembly of any one of claims 71 to 94, wherein the acoustic energy has a frequency of about 1.2 Mhz.

99. The assembly of any one of claims 71 to 94, wherein the acoustic energy has a frequency of about 1.3 Mhz.

100. The assembly of any one of claims 71 to 94, wherein the acoustic energy has a frequency of about 1.4 Mhz.

101. The assembly of any one of claims 71 to 94, wherein the acoustic energy has a frequency of about 1.5 Mhz.

102. The assembly of any one of claims 71 to 94, wherein the acoustic energy has a frequency of about 1.6 Mhz.

103. The assembly of any one of claims 71 to 94, wherein the acoustic energy has a frequency of about 1.7 Mhz.

104. The assembly of any one of claims 71 to 94, wherein the acoustic energy has a frequency of about 1.8 Mhz.

105. The assembly of any one of claims 71 to 94, wherein the acoustic energy has a frequency of about 1.9 Mhz.

106. The assembly of any one of claims 71 to 94, wherein the acoustic energy has a frequency of about 2 Mhz.

107. The assembly of any one of claims 71 to 94, wherein the acoustic energy has a frequency of about 3 Mhz.

108. The assembly of any one of claims 71 to 94, wherein the acoustic energy has a frequency of about 4 Mhz.

109. The assembly of any one of claims 71 to 94, wherein the acoustic energy has a frequency of about 5 Mhz.

110. The assembly of any one of claims 71 to 94, wherein the acoustic energy has a frequency of about 6 Mhz.

111. The assembly of any one of claims 71 to 94, wherein the acoustic energy has a frequency of about 7 Mhz.

112. The assembly of any one of claims 71 to 94, wherein the acoustic energy has a frequency of about 8 Mhz.

113. The assembly of any one of claims 71 to 94, wherein the acoustic energy has a frequency of about 9 Mhz.

114. The assembly of any one of claims 71 to 94, wherein the acoustic energy has a frequency of about 10 Mhz.

115. The assembly of any one of claims 71 to 94, wherein the acoustic energy has a frequency of about 11 Mhz.

116. The assembly of any one of claims 71 to 94, wherein the acoustic energy has a frequency of about 12 Mhz.

117. The assembly of any one of claims 71 to 94, wherein the acoustic energy has a frequency of about 13 Mhz.

118. The assembly of any one of claims 71 to 94, wherein the acoustic energy has a frequency of about 14 Mhz.

119. The assembly of any one of claims 71 to 94, wherein the acoustic energy has a frequency of about 15 Mhz.
